(19) United States
(12) Patent Application Publication
(10) Pub. No.: US 2018/0288989 A1
(43) Pub. Date: Oct. 11, 2018

(54) Apparatus for attracting fish and methods for using the same

(71) Applicant: CASEY JAY COOPER, Wenatchee, WA (US)

(72) Inventor: CASEY JAY COOPER, Wenatchee, WA (US)

(21) Appl. No.: 15/330,986

(22) Filed: Sep. 6, 2017

Related U.S. Application Data
(60) Provisional application No. 62/384,537, filed on Sep. 7, 2016.

(51) Int. Cl. A01K 85/01; A01K 97/05; A01K 85/14

(52) U.S. Cl. CPC A01K 85/01; A01K 85/14; A01K 97/05

(57) ABSTRACT

An apparatus and method for attracting fish is provided. The apparatus is an oblong flasher, comprised of a planar mid-section and planar ends. The plane of each end extends from an exclusive end of the mid-section. The plane of the mid-section and the planes of each end are different. The mid-section are partitioned into first and second layers. The first layer has a proximal and distal side and the second layer has a proximal and distal side. The proximal side of the first layer is releasably coupled axially along a length of the mid to the proximal side of the second layer. The first and second layers close flush to one another. The first layer and a second layer form a hollow compartment between them. The hollow compartment holds bait or scent. The hollow compartment can contain enough bait or scent to stay baited for at least 2 hours.

### FIELD OF THE INVENTION

The present invention relates generally to an apparatus for attracting fish. More specifically, the present invention relates to additions to flasher lures directed to storing and dispersing bait or scent to enhance the ability of the flasher lures to attract fish.

### BACKGROUND

Flashers are used in fishing in combination with a lure and hook as a way to attract fish. When towed in the water, a flasher produces an irregular reflective pattern that is attractive to fish. Another method of attracting fish is the use of attractive scents or bait, such as whole or processed sardines, whole or processed shrimp, haddock, tuna, or scented bait. However, the common methods of dispersing attractive scents or bait into the water only last for several minutes, and are too small to use whole small bait fish or shrimp. Whole small bait fish or shrimp have a different scent profile then when processed, and which will attract different types of fish. Therefore, there is a need for a flasher that also serves to dispense attractive scents or bait, and dispenses continuously for up to two hours.

### SUMMARY OF THE INVENTION

A first aspect of the present invention provides an apparatus for attracting fish. The apparatus is an oblong flasher, comprised of a planar mid-section and planar ends. The plane of each end extends from an exclusive end of the mid section. The plane of the mid-section and the planes of each end are different. The mid-section is partitioned into first and second layers. The first layer has a proximal and distal side and the second layer has a proximal and distal side. The proximal side of the first layer is releasably coupled axially along a length of the mid to the proximal side of the second layer. The first and second layers close flush to one another. The first layer and a second layer form a hollow compartment between them. The hollow compartment holds bait or scent. The hollow compartment can contain enough bait or scent to stay baited for up to 2 hours. The hollow compartment is large enough to contain whole small bait fish or shrimp. The hollow compartment has at least one hole that allows water to freely move in and through the hollow compartment allowing the bait or scent to mix with the water around the apparatus for attracting fish. The flasher has a visual stimulant on the distal sides of the first and second layers such as prismatic tape. The oblong flasher moves in a full 360 degree circle 2 to 5 foot in radius when pulled through the water on a fishing line.

A second aspect of the present invention provides an apparatus for dispensing scent into a body of water. The apparatus has an oblong panel, comprised of a planar mid-section, a front planar end portion, and a back planar end portion. The oblong panel is partitioned into first and second layers. Said end portions are transversely bent across the panel and angled relative to the plane of the mid-section, said end portions being bent in opposite direction parallel planes with degrees of angulation being represented by θ₁, θ₂ with respect to the plane of said mid-section and extend for approximately equal lengths at each end of the mid-section. The oblong panel includes a hollow compartment, said hollow compartment being in direct communication with at least two openings, one opening at a front end of the body and the other opening at the other end of the body. The oblong panel has been partitioned along its longitudinal axis into releasably coupled first and second layers. A transitional fin mounted on said back planar end of said panel on a distal side of said second layer of said panel interposes the transitional fin between a plane of said back planar end and a plane of said mid-section. The transitional fin extends substantially across the width of said back planar end and has a height approximately equal to the height that the back planar end, projecting above the plane of the adjacent surface of the mid-section of said panel. This results in the apparatus being able to move in a full 360 degree circle with a 3 to 5 foot in radius when pulled through the water on a fishing line. Scent or bait is also deposited between the layers of the planar mid-section.

### BRIEF DESCRIPTION OF THE FIGURES

The features of the invention are set forth in the appended claims. The invention itself, however, will be best understood by reference to the following detailed description of an illustrative embodiment when read in conjunction with the accompanying drawings, wherein:

FIG. 1 depicts an elevation view of an apparatus, e.g. a flasher or a dodger, in accordance with embodiments of the present invention;

FIG. 2 depicts a side cross-sectional view of the apparatus, e.g. the flasher or dodger depicted in FIG. 1, in accordance with embodiments of the present invention;

FIG. 3 depicts an elevation view of the apparatus 1, e.g., a dodger 27, in accordance with embodiments of the present invention;

FIG. 4 depicts a transverse cross-sectional view of the dodger shown in FIG. 3, in accordance with embodiments of the present invention;

FIG. 5 depicts a transverse cross-sectional view of the apparatus shown in FIG. 1, e.g., a flasher or a dodger 27 after charging a compartment with bait or scent, in accordance with embodiments of the present invention;

FIG. 6 depicts a flow diagram of a method for method for attracting fish, in accordance with embodiments of the present invention.

### DETAILED DESCRIPTION OF THE EMBODIMENTS

Definitions:

Hereinafter, unless otherwise stated, the term “flasher” is defined as fish attractors that rotate in a full 360 degree circle when pulled through the water on a fishing line, imparting attraction and erratic movement to trailing lures.

Hereinafter, unless otherwise stated, the term “dodger” is defined as a fish attractor that moves in a side-to-side swaying action when pulled through the water on a fishing line, imparting attraction and erratic movement to trailing lures.

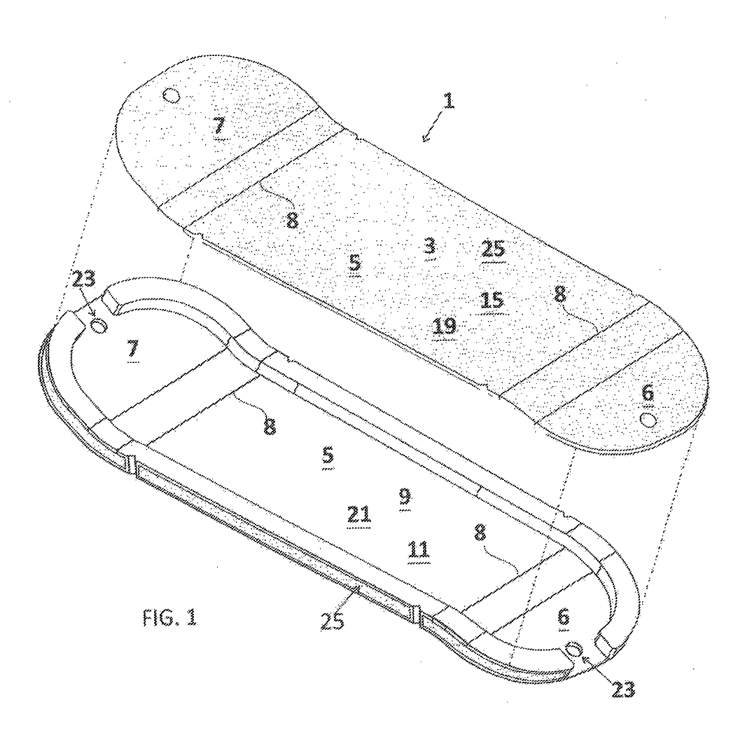

Referring to FIGS. 1-5 as used herein, unless otherwise defined, the terms “distal side” and “proximal side” refer to sides of the first and second layers 9, 15 of the oblong panel 3 of the rolling apparatus 1 or the dodger 27 in relation to the bait or scent 47 in the compartment 21. The “distal side” is farther away from the bait or scent 47 and the “proximal side” is closer to the bait or scent 47.

As used herein, unless otherwise defined, the term “releasably coupling” or “releasably coupled” or “releasably joined” is defined as forming or braking or cleaving or severing of a mechanical coupling between the first and second layers 9, 15 of the oblong panel 3 of the rolling apparatus 1 or the dodger 27, depicted in FIGS. 1-5 and described in associated text, herein.

Hereinafter, unless otherwise stated, the term “lure” is defined as a fish attractor with one or more hooks attached to the body.

FIG. 1 depicts an elevation view of an apparatus 1, e.g. a flasher or a dodger 27. A first aspect of the present invention provides an apparatus 1 for attracting fish. The apparatus is an oblong panel 3 comprised of a planar mid-section 5 and planar ends 6, 7. Each end 6, 7 extends from an exclusive end 8 of the mid-section. The plane of the mid-section and the planes of each end are different. The oblong panel 3 is partitioned into first and second layers 9, 15. The first layer has a proximal and distal side 11, 13 and the second layer has a proximal and distal side 17, 19. The proximal side 11 of the first layer 9 is releasably coupled axially along a length of the middle 18 to the proximal side 17 of the second layer 15. The first and second layers 9, 15 close flush to one another. The first layer and a second layer 9, 15 form a hollow compartment 21 between them. The hollow compartment holds bait or scent 47 47. Liquid scent is usually impregnated into an absorbent material, and inserted into the hollow compartment. The hollow compartment 21 can contain enough bait or scent 47 47 to stay baited for up to 2 hours. The hollow compartment 21 is large enough to contain whole small bait fish or shrimp. The hollow compartment has at least one hole 23 that allows water to freely move in and through the hollow compartment allowing the bait or scent 47 to mix with the water around the apparatus for attracting fish. The flasher has a visual stimulant 25 on the distal sides of the first and second layers such as prismatic tape. The oblong flasher moves in a full 360 degree circle 2 to 5 foot in radius when pulled through the water on a fishing line.

The increased width and increased weight of the apparatus 1 from a large hollow compartment 21 changes the profile of the flasher in the water. This increased surface area and weight gives heavier kicks, rolls, pauses and light reflections when the flasher is trolled through the water. This allows fish to feel and see the flasher from a further distance away.

The increased width, weight, holes 23 and hollow compartment 21 filled with bait and scent or unfilled, also result in additional drag in the water. This causes a hook to set itself upon a fish more securely when the fish hits the lure because the weight of the apparatus 1 pulls on the hook when a fish hits the lure. This results in more successfully hooked fish. In addition, water flowing through the holes 23 mixes with the bait or scent 47, dispersing the bait or scent 47 in heavier trails as the water flows out of the apparatus 1.

In an embodiment, the additional weight of the bait decreases the rotational velocity of the apparatus 1.

In an embodiment, fins 37 may be added for additional control of the path of the apparatus 1 through the water when pulled through the water on a fishing line 43.

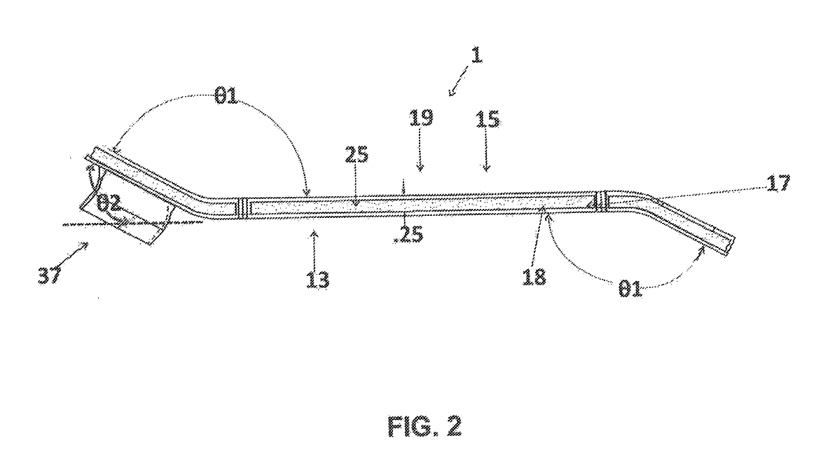

In an embodiment, a transitional fin 37 may be added for additional control of the path of the oblong panel 3 through the water when pulled through the water on a fishing line 43. A transitional fin 37 is mounted on the back planar end 7 of the oblong panel 3 on the distal side 19 of the second layer 15 of the oblong panel 3 which interposes said transitional fin 37 between a plane of said back planar end 7 and a plane of said mid-section 5, said transitional fin 37 extending substantially across the width of said back planar end 7 and having a height approximately equal to the height that the back planar end 7 projects above the plane of the adjacent surface of the mid-section 5 of said oblong panel 3. The inventors have found the transitional fin 37 enables the flasher depicted in FIG. 1 or 2 to move in a full 360 degree circle 3 to 5 foot in radius when pulled through the water on a fishing line 43.

In an embodiment, the weight of the apparatus 1 may be adjusted for optimal rotational velocity. Different rotational velocities are more attractive to different species of fish. By allowing the apparatus 1 to have its rotational velocity adjusted the fisherman can optimize it for his desired catch.

In an embodiment, the bait used in the hollow compartment 21 is selected from the group consisting of whole or processed sardines, whole or processed shrimp, haddock, tuna, or scented bait.

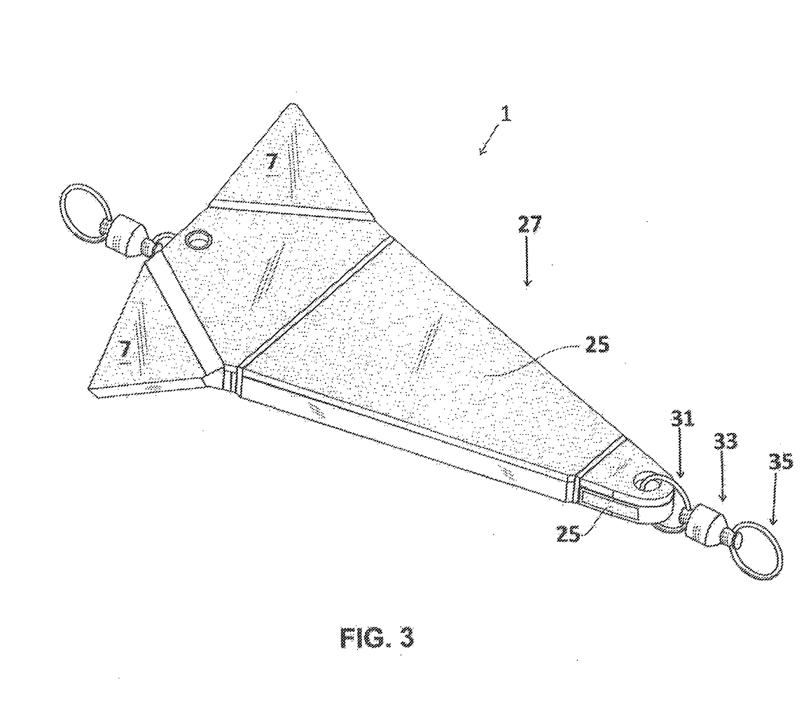

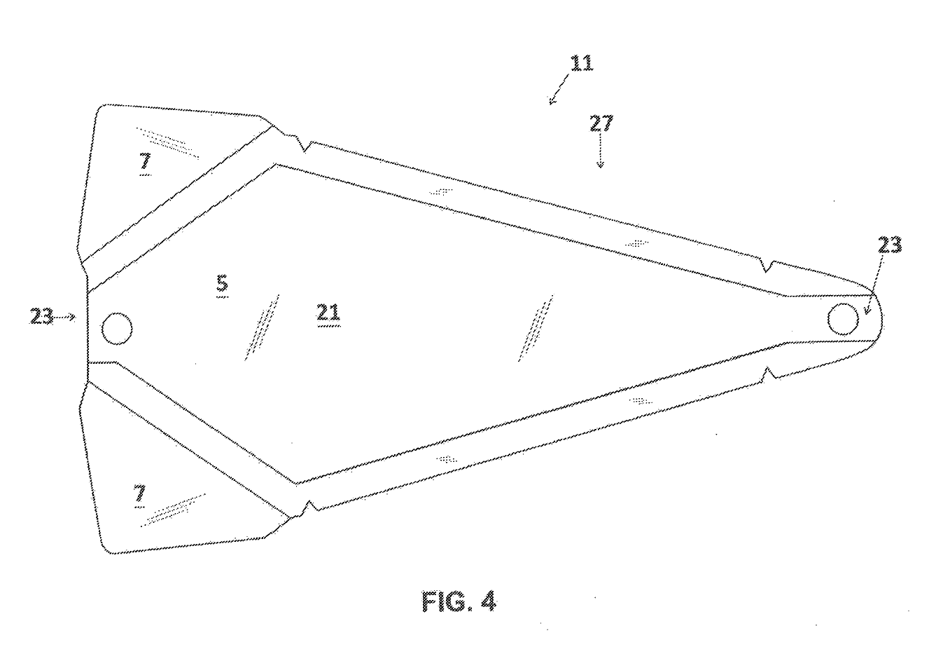

In an embodiment, the attractor is a dodger 27, as shown in FIGS. 3 and 4, or a rolling apparatus 1, as shown in FIGS. 1 and 2.

In an embodiment, the apparatus 1 has a width of at least 0.5 cm.

FIG. 3 depicts an elevation view of the apparatus 1, e.g. a dodger 27. In an embodiment, the fishing line 43 is releasably coupled to the flasher by means of a ringlet 31 releasably coupled to a ring 33 releasably coupled to a swivel 35 releasably coupled to a ring releasably releasably coupled to a line.

In an embodiment, the dodger 27 weighs more than three ounces when empty.

FIG. 2 depicts a side cross-sectional view of the apparatus 1, e.g. the flasher or dodger depicted in FIG. 1. In one embodiment, the planar ends 6, 7 of the attractor form an angle in a range from 137 to 165 degrees with the planar mid-section 5.

In an embodiment, the arrangement of planar ends 6, 7, weight of the apparatus and bait and holes result in drag when the apparatus is pulled through water, resulting in a slower roll, slight wobble, and/or brief pause in rotation.

FIGS. 1 and 2 depict a apparatus 1 for dispensing scent into a body of water. The apparatus 1 includes an oblong panel 3. The oblong panel 3 includes a planar mid-section 5, a front planar end portion 6 and a back planar end portion 7. The oblong panel 3 is partitioned into first and second layers 9, 15. The end portions 6, 7 are transversely bent across the panel 3 and angled relative to the plane of the mid-section 5, said end portions 6, 7 being bent in opposite direction parallel planes with degrees of angulation being represented by θ₁, θ₂ with respect to the plane of the mid-section and extend for approximately equal lengths at each end of the mid-section. The oblong panel 3 includes a hollow compartment 21. The hollow compartment 21 being in direct communication with at least two openings 23, one opening 23 at a front end of the oblong panel 3 and the other opening 23 at the other end of the oblong panel 3. The oblong panel 3 has been partitioned along its longitudinal axis into releasably coupled first and second layers 9, 15.

A transitional fin 37 may be added for additional control of the path of the oblong panel 3 through the water when pulled through the water on a fishing line 43. A transitional fin 37 is mounted on the back planar end 7 of the oblong panel 3 on the distal side 19 of the second layer 15 of the oblong panel 3 which interposes said transitional fin 37 between a plane of said back planar end 7 and a plane of said mid-section 5, said transitional fin 37 extending substantially across the width of said back planar end 7 and having a height approximately equal to the height that the back planar end 7 projects above the plane of the adjacent surface of the mid-section 5 of said oblong panel 3. The inventors have found the transitional fin 37 enables the flasher depicted in FIG. 1 or 2 to move in a full 360 degree circle 3 to 5 foot in radius when pulled through the water on a fishing line 43. Bait or scent 47 is deposited between the layers 9, 15 of the planar mid-section 5.

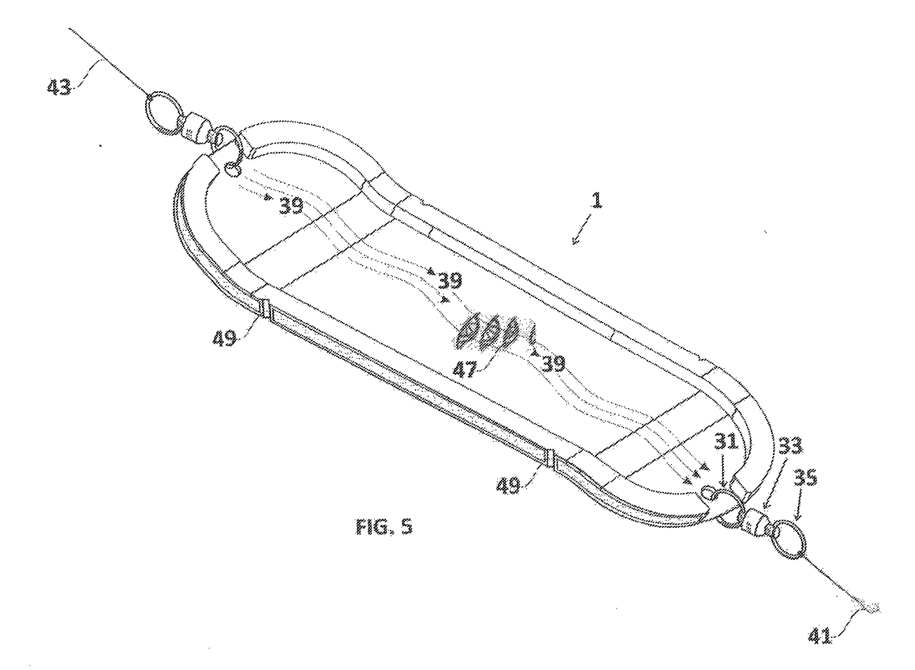

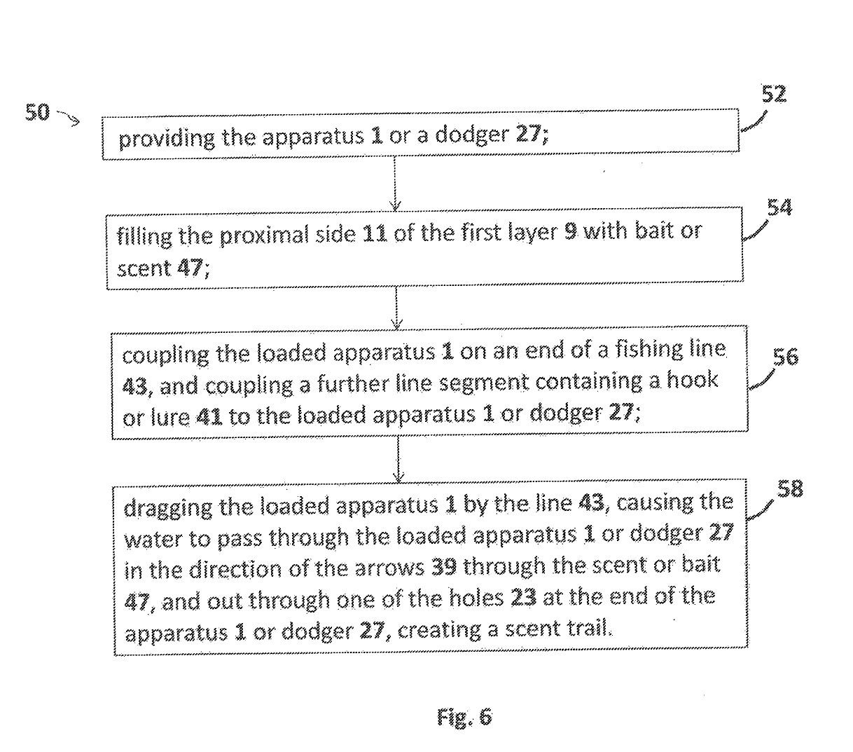

FIG. 6 depicts a flow diagram for a method 50 for attracting fish. In a step 52 of the method 50, the apparatus 1 or a dodger 27 is provided; In a step 54, the proximal side 11 of the first layer 9 is filled with bait or scent 47; In a step 56, the proximal side 17 of the second layer 15 is releasably coupled to the proximal side 11 of the first layer 9 such that the coupling is flush along the sides, forming a hollow compartment 21. This creates a loaded apparatus 1 or dodger 27. In a step 58, the loaded apparatus 1 is coupled to an end of a fishing line 43, and a further line segment containing a hook or lure 41 is coupled to the loaded apparatus 1 or dodger 27. The loaded apparatus 1 is then dragged by the line 43, causing the water to pass through the loaded apparatus 1 or dodger 27 in the direction of the arrows 39, depicted in FIG. 5, and described in associated text, herein, through the scent or bait 47, and out through one of the holes 23 at the end of the apparatus 1 or dodger 27, creating a scent trail.

In an embodiment, the additional weight of the bait is calibrated to decrease the rotational velocity of the apparatus to attract specific species of fish.

In an embodiment, the weight of the loaded flasher or dodger 27 may be adjusted for optimal rotational velocity.

In an embodiment, the angle formed between the planar mid-section 5 and the planer ends 6, 7 is in a range from 137 to 165 degrees.

In an embodiment, the apparatus 1 has a width of at least 0.5 cm.

In an embodiment, the apparatus 1 weighs more than three ounces when empty.

In an embodiment, the bait used in the hollow compartment 21 is selected from the group consisting of whole or processed sardines, whole or processed shrimp, haddock, tuna, or scented bait.

In an embodiment, the arrangement of planar ends 6, 7, weight of the apparatus 1, bait and holes result in drag when the apparatus is pulled through water, resulting in a slower roll, slight wobble, and/or brief pause in rotation.

FIG. 4 depicts a transverse cross-sectional view of the dodger 27 shown in FIG. 3, including the planar ends 7 and the hollow compartment 21. Tables 1 and 2, infra, is a comparison of the linear length, width and thickness dimensions of the rolling apparatus 1 and dodger 27 of the present teachings.

TABLE 1
Comparison of the Linear Length, Width and Thickness Dimensions
of the Rolling Apparatus 1 of the Present Teachings.

| Mid-Section (cm) | | | Ends (cm) | | |
|---|---|---|---|---|---|
| Length | Width | Thickness | Length | Width | Thickness |

First layer 9

| | | | | |
|---|---|---|---|---|
| At least | At least | At least | At least | At least 1.8 |
| 5.8 | 1.8 | 0.3175 | 1.94 | |

Second layer 15

| At least | At least | At least | At least | At least 1.8 | At least |
|---|---|---|---|---|---|
| 5.8 | 1.8 | 0.3175 | 1.94 | | 0.3175 |
| | | Cavity | | | |
| | | Thickness | | | |
| | | 0.635 | | | |
| | | | | Total Weight | |
| | | Total | Total | (compartment | Total |
| | | Thickness | Length | 21 empty) | Thickness |
| | | 0.3175-0.9525 | At least | 4.0 grams | 0.3175- |
| | | | 9.7 | | 0.9525 |

Transitional Fin (cm)

| Length | Height |
|---|---|
| At least | At least |
| 2.9 | 0.7 |

TABLE 2
Comparison of the Linear Length, Width and Thickness Dimensions
of the Dodger 27 of the Present Teachings.

| | |
|---|---|
| Total Length | at least 18.8 cm |
| Total Width | At least 7.0 cm |
| Width of openings 23 | At least 0.8 cm |
| Depth of Compartment 21 | At least 0.06 cm |
| Total Bottom Thickness | At least 0.08 cm |
| Couplings 49 recess | At least 0.06 cm |

In a preferred embodiment, the flasher has a thickness of 0.31 to 0.9525 centimeters, and weighs 4 grams empty. When filled with bait, the weight of the flasher can increase to at least 9.6 grams. In a preferred embodiment, the flasher has a width of 1.8 centimeters, and a length of 9.7 centimeters.

Generally, a length of the ends 6, 7 of the rolling apparatus 1 is about 20% of the length of the mid-section 5. In a preferred embodiment, the length of the transitional fin 37 is 2.9 cm and the height is 0.7 cm.

FIG. 5 depicts a transverse cross-sectional view of the apparatus shown in FIG. 1, e.g., a flasher or a dodger 27, after charging a compartment 21 with bait or scent 47. The loaded apparatus 1 may be dragged by the fishing line 43, causing the water to pass through the loaded apparatus 1 or dodger 27 in the direction of the arrows 39, depicted in FIG. 5, and described in associated text, herein, through the scent or bait 47, and out through one of the holes 23 at the end of the apparatus 1 or dodger 27, creating a scent trail.

The apparatus 1 and dodgers 27 depicted in FIGS. 1-5 and described in associated text, herein, are known as fish Attractors, referred as a scent-able flasher or dodger. This Attractor is made with 2 pieces, e.g., first and second layers 9, 15, that fit together with a chamber 21 between them to hold fish bait or scent 47. The first and second layers 9, 15 of the Attractor may be releasably coupled using pin in groove snaps, Velcro straps, or elastic bands that releasably couple to oppositely disposed slots or grooves 49. The Attractor has one or more holes 23 in the front and back to allow water to flow through and disperse the bait or scent 47 from the chamber 21. There are standard fish attractants (dodgers/flashers) but none of them hold bait or scent, or have a cavity between the two pieces.

In a preferred embodiment, the dodger 27 has a width of at least 0.8 centimeters, and weighs 3.2 grams empty. When filled with bait, the weight of the dodger 27 can increase to at least 5.7 grams.

The foregoing description of the embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

I claim:

1. An apparatus (1) for attracting fish, comprising:
an oblong panel (3), comprising:
a planar mid-section (5) and planar ends (7)
wherein each end extends from an exclusive end (8) of the mid-section (5),
wherein the plane of the mid-section (5) and the planes of each end (7) are different,
wherein the oblong panel (3) is partitioned into first and second layers (9, 15),
wherein the first layer (9) has a proximal and distal side (11, 13) and the second layer has a proximal and distal side (17, 19),
wherein the proximal side of the first layer is releasably coupled axially along a length of the mid-section to the proximal side of the second layer,
wherein the first and second layers close flush to one another,
wherein the first layer and a second layer form a hollow compartment (21) between them,
wherein the hollow compartment holds bait or scent (47),
wherein the hollow compartment can contain enough bait or scent to stay baited for at least 2 hours,
wherein the hollow compartment is large enough to contain whole small bait fish or shrimp, and
wherein the hollow compartment has at least two holes (23) that allows water to freely move in and through the hollow compartment allowing the bait or scent to mix with the water around the apparatus for attracting fish; and
a visual stimulant on the distal sides of the first and second layers such as prismatic tape,
wherein the apparatus moves in a full 360 degree circle 2 to 5 foot in radius when pulled through the water on a fishing line (43).

2. The apparatus of claim 1, wherein the oblong panel (3) moves in a side to side swaying motion when pulled through the water on a fishing line (43).

3. The apparatus of claim 1, wherein the additional weight of the bait (47) decreases the rotational velocity.

4. The apparatus of claim 3, wherein the weight of the bait may be adjusted for optimal rotational velocity.

5. The apparatus of claim 1, wherein the bait used in the hollow compartment is selected from the group consisting of whole or processed sardines, whole or processed shrimp, haddock, tuna, or scented bait.

6. The apparatus of claim 1, wherein the rolling flasher has a thickness of at least 0.5 cm.

7. The apparatus of claim 1, wherein the fishing line is releasably coupled to the apparatus by means of a ringlet releasably coupled to a ring releasably coupled to a swivel releasably coupled to a ring releasably releasably coupled to a line.

8. The apparatus of claim 1, wherein the apparatus weighs more than three ounces when empty.

9. The apparatus of claim 1, wherein the planar ends (7) form an angle in a range from 137 to 165 degrees with the planar mid-section.

10. The apparatus of claims 1, wherein the arrangement of planar ends, weight of the apparatus and bait and holes result in drag when the apparatus is pulled through water, resulting in a slower roll, slight wobble, and/or brief pause in rotation.

11. The apparatus of claim 1, wherein said end portions (7, 7) are transversely bent across the panel (3) and angled relative to the plane of the mid-section (5), said end portions (7, 7) being bent in opposite direction parallel planes with degrees of angulation being represented by θ₁, θ₂ with respect to the plane of said mid-section and extend for approximately equal lengths at each end of the mid-section, and further comprising:
a transitional fin (37) mounted on said back planar end (7) of said panel (3) on a distal side (19) of said second layer (15) of said panel (3) which interposes said transitional fin (37) between a plane of one of the planar ends (7) and a plane of said mid-section (5), said transitional fin (37) extending substantially across the width of said planar end (7) and having a height approximately equal to the height that the planar end (7) projects above the plane of the adjacent surface of the mid-section (5) of said panel (3), resulting the rolling flasher (1) being able to move in a full 360 degree circle 3 to 5 foot in radius when pulled through the water on a fishing line (43

12. A method for attracting fish, comprising
providing the rolling flasher of claim 1, or a dodger;
filling the proximal side of the first layer with bait or scent;
operably coupling the proximal side of the second layer to the proximal side of the first layer such that the coupling is flush along the sides, forming a hollow compartment;
placing the loaded loaded rolling flasher or dodger on an end of a fishing line, and attaching to the loaded rolling flasher or dodger a further line segment containing a hook;
dragging the loaded rolling flasher or dodger by the line, causing the water to pass through the loaded rolling flasher or dodger, through the scent or bait, and out the back of the loaded rolling flasher or dodger, creating a scent trail.

13. The method of claim 12, wherein the additional weight of the bait is calibrated, decreasing the rotational velocity of the oblong flasher to attract specific species of fish.

14. The method of claim 12, wherein the weight of the rolling flasher or dodger may be adjusted for optimal rotational velocity.

15. The method of claim 12, wherein an angle formed between the planar mid-section and the planer ends is in a range from 137 to 165 degrees.

16. The method of claim 12, wherein the apparatus has a thickness of at least 0.5 cm.

17. The method of claim 12, wherein the apparatus weighs more than three ounces when empty.

18. The method of claim 12, wherein the bait used in the hollow compartment is selected from the group consisting of whole or processed sardines, whole or processed shrimp, haddock, tuna, or scented bait.

19. The method of claim 12, wherein the arrangement of planar ends, weight of the apparatus and bait and holes result in drag when the apparatus is pulled through water, resulting in a slower roll, slight wobble, and/or brief pause in rotation.

20. A rolling flasher (1) for dispensing scent into a body of water, comprising:
an oblong panel (3), comprising:
a planar mid-section (5), a front planar end portion (6) and a back planar end portion (7),
wherein the oblong panel (3) is partitioned into first and second layers (9, 15),
wherein said end portions (6, 7) are transversely bent across the panel (3) and angled relative to the plane of the mid-section (5), said end portions (6, 7) being bent in opposite direction parallel planes with degrees of angulation being represented by θ₁, θ₂ with respect to the plane of said mid-section and extend for approximately equal lengths at each end of the mid-section,
wherein the oblong panel (3) includes a hollow compartment (21), said hollow compartment (21) being in direct communication with at least two openings (23), one opening (23) at a front end of the oblong panel (3) and the other opening (23) at the other end of the oblong panel (3),
wherein the oblong panel (3) has been partitioned along its longitudinal axis into releasably coupled first and second layers (9, 15);
a transitional fin (37) mounted on said back planar end (7) of said panel (3) on a distal side (19) of said second layer (15) of said panel (3) which interposes said transitional fin (37) between a plane of said back planar end (7) and a plane of said mid-section (5), said transitional fin (37) extending substantially across the width of said back planar end (7) and having a height approximately equal to the height that the back planar end (7) projects above the plane of the adjacent surface of the mid-section (5) of said panel (3), resulting the rolling flasher (1) being able to move in a full 360 degree circle 3 to 5 foot in radius when pulled through the water on a fishing line (43); and
scent deposited between the layers (9. 15) of the of the planar mid-section (5).
